(19) United States
(12) Patent Application Publication
(10) Pub. No.: US 2018/0148193 A1
(43) Pub. Date: May 31, 2018

(54) VISUAL TOOL FOR PILOTS

(71) Applicant: Cenan Ozmeral, Flagler Beach, FL (US)

(72) Inventor: Cenan Ozmeral, Flagler Beach, FL (US)

(21) Appl. No.: 15/826,369

(22) Filed: Nov. 29, 2017

Related U.S. Application Data
(60) Provisional application No. 62/427,230, filed on Nov. 29, 2016.

(51) Int. Cl. B64D 45/06; G01C 9/00; G01C 9/20

(52) U.S. Cl. CPC B64D 45/06; G01C 9/20; G01C 9/005

(57) ABSTRACT

Disclosed is a visual tool for determining the spatial orientation of an aircraft relative to a level plane, including a closed container constructed of a material that permits the passage of light therethrough. An indicator body is fixed within the container and viewable through the container. An indicator fluid is provided including a liquid that fills the container a selected amount. The indicator fluid presents a fluid surface that is viewable through the container and free to move within the container. When the visual tool is affixed to an aircraft the indicator body and the fluid surface are parallel to the level plane when the aircraft is level. The indicator body is moved out of the level plane and the fluid surface remains parallel to the level plane when the aircraft deviates from the level plane to generate a visual signal representative of the orientation of the aircraft.

### CROSS-REFERENCE TO A RELATED APPLICATION

This patent application claims benefit of U.S. Provisional Patent Application No. 62/427,230, filed Nov. 29, 2016, the invention of which is incorporated by reference in its entirety for all purposes.

### BACKGROUND OF THE INVENTION

Pilots face challenges while flying aircrafts in darkness or under cloud cover without any visual cues. Human beings use visual cues to have a sense of orientation with reference to their surroundings. Human beings can become disoriented when in dark or foggy conditions where there are few or no visual cues. In addition to the visual system, the semicircular and somtogyral canals of the vestibular system of the human ear contribute to the sense of balance and spatial orientation. However, under conditions where an external visual reference is unavailable or unreliable, the vestibular system can supply false or confusing sensations during rotation and/or other motions. The illusions from the human vestibular system resulting from a lack of visual cues can cause dangerous conditions such as leans, graveyard spin, graveyard spiral, and Coriolis illusion. As a result, pilots can become disoriented, which can result in a crash.

Control of civil aviation aircraft operations include two sets of regulations, namely: Visual Flight Rules (VFR) and Instrument flight Rules (IFR). Under relatively clear weather conditions, pilots fly their planes solely by reference to visual cues under VFR. Pilots flying aircrafts under VFR can use the visual cues from outside the aircraft as the primary source for keeping the aircraft straight and in proper orientation and are not required to use cockpit instruments as secondary aids for navigation and orientation. However, an aircraft operated under VFR is required to have instruments to operate the aircraft under IFR. Any weather condition that requires the operation of an aircraft under VFR is referred to as visual meteorological conditions (VMC). Flying an aircraft under VFR is generally simpler than flying an aircraft under IFR.

IFR permits a pilot to operate an aircraft in instrument meteorological conditions (IMC), which is essentially any weather condition less than VMC. Pilots are deprived of visual cues during night flights and while flying under IMC. As a result, while operating the flight during night time and under IMC, pilots can be easily disoriented. Spatial orientation and loss of situational awareness by a pilot while flying an aircraft at night and under IMC is a significant factor in many airplane accidents.

Efforts have been made to solve the foregoing problem by providing pilots with attitude-orientation cues using attitude indicators (known as Artificial Horizons and gyro horizon) and Heads-Up Displays. The traditional, self-contained attitude indictors use a gyroscope powered via vacuum, electricity, or a laser, for example. One drawback associated with these types of equipment is that they can fail to improve the pilot's situational awareness and spatial orientation during night flying and IMC flying. The problem associated with this type of cockpit equipment can be attributed to the fact that these devices do not tell the pilot whether the aircraft is climbing, diving or turning. Instead, these equipment provide the pilot with data related to a rate of climbing, diving or turning, and pilot has the task of determining the spatial orientation based on the display in the instrument panel. Thus, IMC flying using the current equipment panel in the cockpit requires more processing time than analogous natural process in the natural environment. Moreover, understanding the instrument panel is a learned skill, which can easily be lost under a disoriented condition. Therefore, there is an unmet need to provide the pilots with a system that can display simple visual cues indicating a current flight orientation.

### BRIEF SUMMARY OF THE INVENTION

The present invention relates to visual tools for pilots that supply spatial information in place of or supplemental to existing attitude indicators when the indicators are either difficult to understand, are turned off, or malfunction. Disclosed herein is an inexpensive visual tool that will not fail as it uses gravitational forces to operate, i.e., no external source of power, and requires only visual observations of the pilot or other viewer. Accordingly, the present invention provides a visual tool that enables the pilot to determine the orientation of an aircraft under conditions where there are confusing, few, or no visual cues regarding the aircraft. By using the visual tool of the present invention, the pilot will be able to fly the aircraft effectively under IMC and reduce the possibility of accidents. Aircraft or airplane will refer herein to any type of craft that is capable of flight.

In an embodiment, the present invention provides a visual tool for determining the spatial orientation of an aircraft relative to a level plane, including a closed container constructed of a material that permits the passage of light therethrough. An indicator body is fixed within the container and viewable through the container. An indicator fluid is provided including a liquid that fills the container a selected amount. The indicator fluid presents a fluid surface that is viewable through the container and free to move within the container. When the visual tool is affixed to an aircraft the indicator body and the fluid surface are parallel to the level plane when the aircraft is level. The indicator body is moved out of the level plane and the fluid surface remains parallel to the level plane when the aircraft deviates from the level plane to generate a visual signal representative of the orientation of the aircraft.

Other aspects of the present invention include wherein the container is translucent or transparent. The container can be made out of glass or plastic. The container can be one of spherical, rounded, square, and rectangular shaped. The liquid can include a colorant. The container can define a volume and the liquid fills about half of the volume. The liquid can be one or more of a water-based fluid, an organic-based fluid, and an oil-based fluid. The indicator body can be in the shape of an aircraft. The aircraft can be an airplane. The container can be sized and shaped to be attached to the top of an instrument panel of an aircraft cockpit in the visual field of the pilot. The visual tool can further include a mount that is configured to attach the container to a structural element of the aircraft. The visual tool can further include an illumination device configured to illuminate an interior of the container. The illumination device can be a light emitting diode. The container can include the indicator fluid and a second fluid, the indicator fluid and the second fluid filling the container. The second fluid is non-miscable with the indicator fluid. The second fluid is of a lesser density than the first. The second fluid permits viewing of an interface between the indicator fluid and the second fluid. The indicator fluid is a darker color than the second fluid. The second fluid can be clear.

The liquid to be used can be a pure liquid or a mixture of two or more liquids or even a solid(s) dissolved in liquid(s) as long as the resulting mixture meets appearance, color, bp, mp, viscosity, and toxicity requirements. The liquid should be clear and see-through. The airplanes markings should be clearly observable in the liquid. A dye can be added to the liquid to provide contrast as long as the see-through nature of the liquid is not lost.

Very low viscosity of the liquid can cause ripples on the surface of the liquid due to the vibrations of the flight and must be minimized or avoided. High viscosity will result in slowing down of the movement of the liquid surface as the plane dips or ascends thus creating a delayed reaction, which should be minimized or avoided. Viscosity of water is 0.0091 Ps (at 20 C) and use of water in this application can permit some ripples on the surface of the liquid during flight making visual observation difficult. Therefore, the viscosity of water can be considered as the low end of liquid viscosity suitable for use. MEG (viscosity at 20 C is 0.016 Ps) and DEG (viscosity at 20 C is 0.036 Ps) has been tested and determined to be acceptable but one can also observe as viscosity is increased, that there is a delayed response of liquid surface to the movements of the plane. In an embodiment, a liquid with a viscocity of higher than 0.05 Ps (20 C) could be unsuitable for use in this application. Therefore in an embodiment, an acceptable viscosity will be in the range of 0.0091 Ps a to 0.05 Ps a (at 20 C).

It is expected that private aviation planes that use the invention will be parked at times in hot climates (such as Arizona, Nevada, etc). While parked, the temperatures inside the cockpit could reach 150 C. Therefore, the liquid should not have high vapor pressure and should have a boiling point of over 150 C.

The liquid should not be toxic to humans (inhalation, chemical absorption, ingestion). There are three ways to categorize toxicity of chemicals: Personal exposure limit (PEL), Threshhold value limit (TLV) and assigned exposure limit (AEL). The toxicity of acceptable liquids for this application will be referred to in terms of its TLV as that is the most commonly used measurement of toxicity. A liquid that is toxic at exposure levels of 400 ppm TLV or higher is considered safe and is approved for this application. A liquid that has a TLV of 100-400 ppm can be handled safely by using protective equipment such as gloves and thus can be used for this purpose. A liquid that has a TLV of less than 100 ppm should not be used for this purpose. Therefore an acceptable range is 100 ppm TLV or higher.

In yet another aspect, the present invention includes a method of indicating the spatial orientation of an aircraft relative to a level plane with a visual tool affixed thereto, wherein the visual tool has an indicator body viewably housed within and fixed to a container and a liquid filling a portion of the container, the method including operating the aircraft parallel to or not parallel to the level plane, permitting a surface of the liquid to be parallel to the level plane regardless of the spatial orientation of the aircraft, causing the indicator body to align with the spatial orientation of the aircraft, wherein, when the aircraft is parallel to the level plane, the indicator body and the surface of the liquid are aligned, and when the aircraft deviates from the level plane, the indicator body and the surface of the liquid are non-aligned; an determining the spatial orientation of the aircraft by comparing the alignment of the indicator body to the surface of the liquid.

In an embodiment, the present invention provides a visual tool comprising a hollow, three-dimensional structure in the form of a container that is partially filled with a liquid to provide signals indicative of the aircrafts attitude relative to the direction of the pull of gravity.

The transparent or translucent, hollow contain can have any suitable shape. In one aspect, the transparent or translucent, hollow, container is spherical in shape. In another aspect of the present invention, the translucent, hollow, container is non-round or non-spherical. In another aspect, the transparent or translucent, hollow, container can be square, rectangular, circular, hexagonal, orthogonal, or multi-cornered in shape.

In one aspect of the present invention, the container is a transparent or translucent plastic or glass material.

In another aspect of the present invention, the liquid used to fill the container includes at least one color adjunct. The liquid can include one or more of water, various mono or multi-functional chemical solvents, and oil.

In another aspect of the present invention, the tool includes an indicator body within the container, e.g., in the shape of an airplane.

In another aspect of the present invention, the visual tool is attached to the top of the instrument panel of the cockpit at a location that is directly in the visual field of the pilot.

In one aspect of the present invention, the visual tool includes a mount attached to the top of the panel of the cockpit at a location to fix the tool in the visual field of the pilot.

In another aspect, the visual tool according to the present invention further includes an illumination device in the form of a source of light. The illumination device can be a light emitting diode attached to the base of the visual tool. The illumination device can be a light emitting diode attached to the container at the bottom or top thereof.

The present invention has one or more technical features and advantages. For example, the invention provides an inexpensive visual tool, which enables a pilot to determine the spatial orientation of the aircraft without the need for any advanced training under the conditions when the pilot is in a disoriented condition. Additionally, the visual tool of the present invention is a fail-proof instrument since it needs only the force of gravity to present orientation information to the viewer. It works on simple mechanical principles and requires neither electricity nor other sources of energy for its operation. It is believed that since the device operates via gravity and is therefore operates according to a trusted principle, it will be a reliable and trusted flight-training tool. It is believed that the present invention will help trainee pilot with their confidence in instrumental attitude indicators as the present invention will operate to agree with those instruments.

### BRIEF DESCRIPTION OF THE SEVERAL VIEWS OF THE DRAWINGS

FIG. 1 is a perspective view of a visual tool according to an embodiment of the invention.

FIG. 2 is a top view of a visual tool according to a second embodiment of the invention.

FIG. 3 is a side view of the visual tool of FIG. 2.

FIG. 4 is a front section view of the visual tool of FIG. 2.

FIG. 5 is a section view of the visual tool of FIG. 3.

FIG. 6 is a side view of the visual tool of FIG. 2 depicting a state of the tool while the aircraft is in a climbing attitude.

FIG. 7 is a side view of the visual tool of FIG. 2 depicting a state of the tool while the aircraft is in a descending attitude.

FIG. 8 is a side view of the visual tool of FIG. 2 depicting a state of the tool while the aircraft is in a banking or turning attitude.

FIG. 9 is a partial exploded view of the visual tool according to the embodiment of FIG. 1.

### DETAILED DESCRIPTION OF EMBODIMENTS OF THE INVENTION

Reference is made herein in detail to specific embodiments of the invention. Specific examples are illustrated with drawings. The subject matters of embodiments of the present invention are provided herein to satisfy the statutory requirement. However, the description provided herein is not meant to limit the scope of the present invention. Rather the claimed subject matter of the present invention can be embodied in several other ways within the scope of the present invention.

The present invention is a visual tool that functions as an attitude indicator for use by pilots operating aircraft at any time, but in particular during darkness or inclement weather conditions in which the pilots are most likely to become disoriented. Unlike currently used attitude indicators employing a gyroscopic or other device, the operation of which requires either air pressure or electricity for operation, the attitude indicator of the present invention is a mechanical device that does not require either electricity or other energy sources for its operation. In addition, the attitude indicator of the present invention provides direct visual cues on the orientation of aircraft to the pilot without instruments or other complex devices. In one embodiment, the present invention provides a visual tool useful to pilots when flying an aircraft either during nighttime or under IMC when there are few useful or no visual cues as to spatial orientation. For purposes of the present invention, when the airplane is aligned with a plane that is orthogonal to the direction of the pull of gravity it will be considered to be in a “level plane” and has a level flight attitude or orientation. In other words, level flight or a level attitude is when the airplane is aligned (wings and fuselage) parallel to a plane that can be generally defined by a level body of water on the surface of the earth. Any deviation from the level plane will involve one or more of climbing, descending or turning. When the airplane is turning, the wings will be considered to be out of the level plane. The present invention is directed to a tool that provides a signal indicative of the attitude of the plane, which can be a level flight attitude in a level plane or a deviation therefrom out of the level plane.

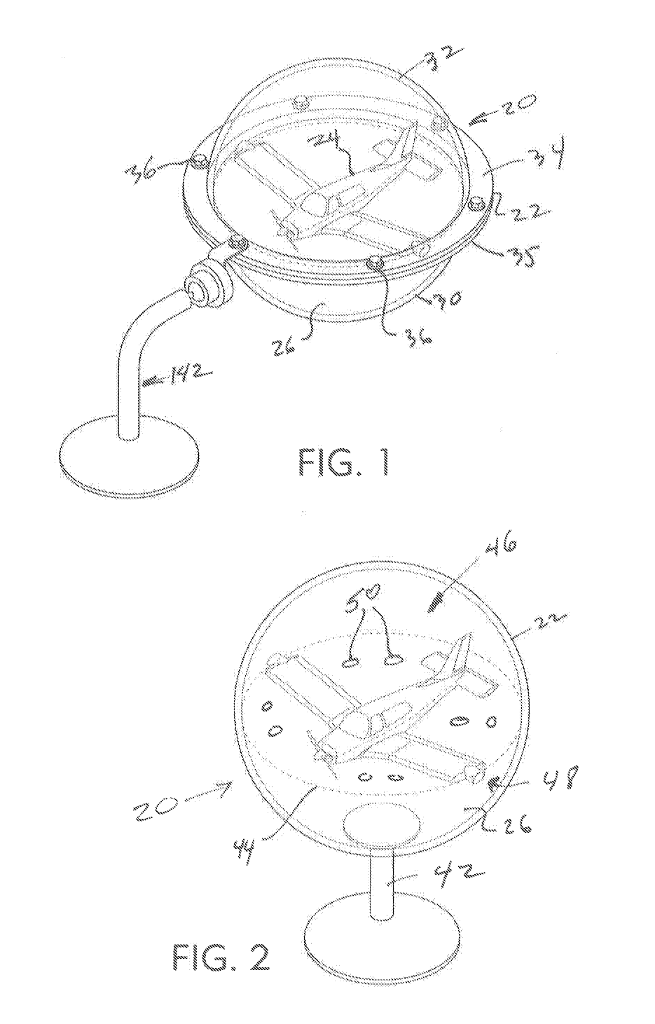

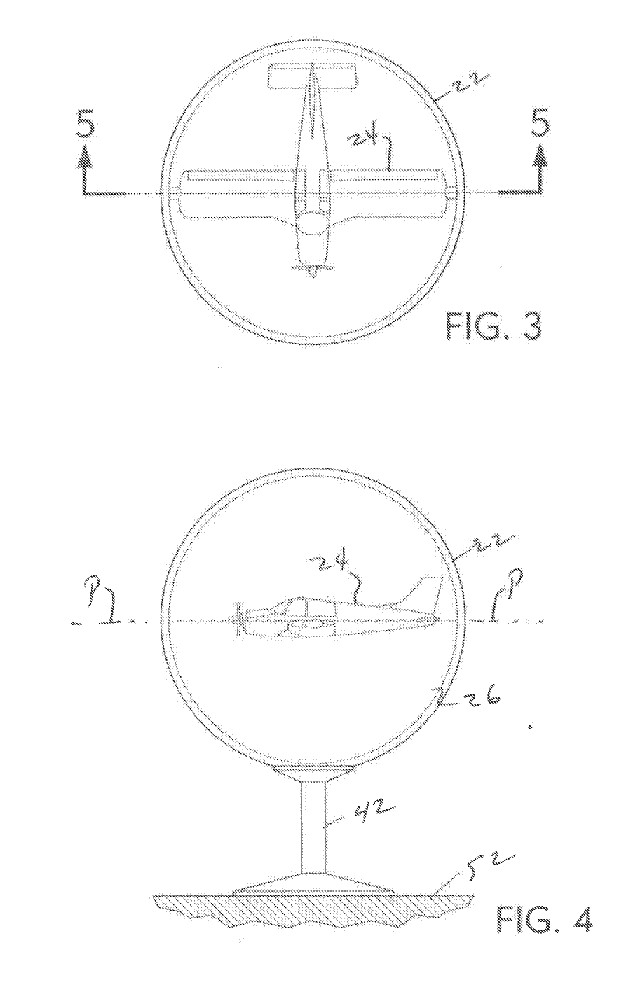

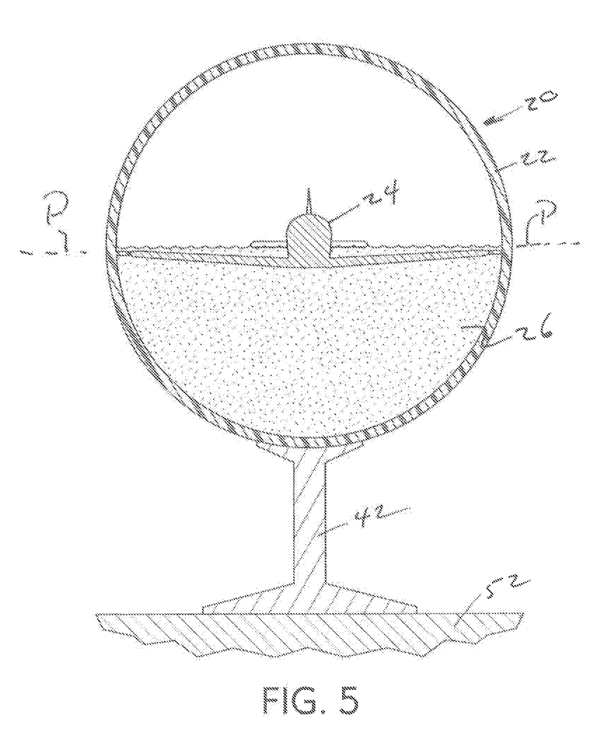

Referring to FIGS. 1-9, the visual tool 20, according to an embodiment of the present invention, includes three main parts: a container 22, an indicator body 24 that is disposed within the container and viewable through the material of the container, and an indicator 26 in the form of a liquid disposed within the container, which fills the container a selected amount and presents a highly visible liquid/gas interface that maintains a generally level attitude in a level plane due to the effects of gravity.

The container 22 can be any suitable shape. One preferred shape is a sphere, but other non-spherical shapes are also contemplated, such as oblate, cylindrical, or other shapes. A sphere can be preferred because it disturbs the stability of the indicator fluid 26 less when the visual tool 20 is rotated by movement of the aircraft in which it is disposed relative to a container with corners or other turbulence-inducing features. Accordingly, in a rounded container, less turbulence and fewer waves are generated by the shape of the container, which provides a more stable and higher quality visual orientation cues to a viewer. The viewer can be a pilot of the aircraft, for example, or a copilot, or a non-pilot operator of the aircraft.

The container 22 can be of any suitable size. The container 22 can be affixed to any stable surface, fixture, or element of the aircraft in a position where it is easily viewable by the viewer. It will be understood that the size of the container 22 will make it easily viewable but not so large that it obscures the pilot's view of any instruments or through the aircraft windows or creates a visual distraction. The container 22 can be one to ten inches in diameter, for example, one to 8 inches, one to 7 inches, one to 6 inches, one to 5 inches, one to 4 inches, one to 3 inches, one to 2 inches, two to 8 inches, two to 6 inches, or any other suitable size.

The container 22 is made of a transparent or translucent material or any material that permits viewing of the internal contents thereof. For example, the container 22 can be made of glass or plastic. Most plastic materials are not transparent or as transparent as glass, but there are numerous suitable plastic materials for use in constructing the container 22 of the present invention. Some examples of suitable transparent or semi-transparent plastic include: acrylics (e.g., polymethylmethacrylate), butyrates (e.g., cellulose acetate butyrate), Lexan (polycarbonate), PETG (glycol modified polyethylene terephthalate), PCTG (polycyclohexylene dimethyleneterephthalate-glycol modified), ethylene-vinyl acetate, polysulfone, polyphenyl sulfone, polyethersulfone, polystyrene, poly (styrene methyl methacrylate), polyethylene, polypropylene, polymethylpentene, polyolefins (PE, PP), Polybutylterephthalate (PBT), Polyethyleneterephthalate (PET), polyesters, Urethanes, polyamides, silicones, and acrylonitrile-butadiene-styrene (ABS), and combinations of one or more of these materials. The thickness of the container 22 can range from about 0.5 millimeter to about 5 millimeters, for example, 1 mm to 4 mm, 1 mm to 3 mm, and so on.

The container 22 can be constructed as a single piece or as two or more pieces. The container can be molded, extruded, or made by additive manufacturing or any suitable manufacturing method. It will be understood that the resulting container 22 should be shatter resistant and able to tolerate a wide range of pressure changes to avoid creating a hazard while the aircraft is being operated. The container 22 should be fluid tight to keep the indicator fluid 26 from escaping. If formed of two parts (FIGS. 1 and 9), the container 22 can include a bottom portion 30 that is provided in fluid tight engagement with a top portion 32. The top and bottom portions 30, 32 can be half-spherical in configuration.

Referring to FIGS. 1 and 9, the top and bottom portions 30, 32 can each include a radially outward extending flange 34, 35, between which a gasket 38 can be disposed. The gasket 38 is of any suitable material, such as plastic, metal or rubber that seals the bottom and top portions 30, 32 and retains the indicator fluid 26 within the container 22. The gasket 38 can be in the form of a flat annular structure or an O-ring or any suitable configuration. Alternatively, it is possible to join the two portion 30, 32 directly to each other and without a flange.

The flanges 34, 35 can be secured to each other by one or more fasteners 36. The fasteners 36 can be screws, rivets, bolts, adhesive, welds or any suitable element, devices, or material(s) that secures the bottom and top portions 30, 32 together. The fasteners 36 can be disposed through the flanges 34, 35 or can be a bond holding the two portions 30, 32 together.

The container 22, if manufactured by additive manufacturing or other methods can also have the configuration of a one-piece construction, and optionally also a one-piece construction including the indicator body 24. The indicator body 24 can be in the shape of an aircraft or any suitable shape that conveys orientation information to the viewer. For example, the indicator body 24 can be an arrow, a conical shape, a rocket shape, or cylindrical. An aircraft shape can be preferred because it can convey orientation information quickly to the viewer. In the illustrated embodiment, the indicator body 24 is in the shape of a common aircraft with its wings attached to the interior of the container 22. In another embodiment, the “nose” and “tail” of the aircraft can be attached to the interior of the container 22. The indicator body 24 can be attached at one or more points. The attachment of the indicator body 24 to the container 22 causes the indicator body to remain stationary relative to the container. In other words, if the container 22 maintains an unchanging orientation relative to gravity, the indicator body 24 also maintains an unchanging orientation. If the container 22 rotates, moves or is moved relative to the direction of the pull of gravity, the indicator body 24, due to it being fixed within the container, also is rotated the same extent. Accordingly, the indicator body 24 provides a signal indicative of the orientation of the visual tool 20, and thus the aircraft, relative to the pull of gravity, because the visual tool 20 is fixed to the aircraft.

The visual tool 20 is secured to the aircraft by a mount 42 that fixes the tool to the airplane. The mount 42 can be any suitable form of mount, for example, a stand, arm, or post and can employ an adhesive, a fastener, a weld, or any suitable attachment method. The mount 42 is secured to the aircraft in a position such that the tool 20 is easily viewable. The mount 42 can be secured to an aircraft window, dashboard, instrument panel (not shown) or any suitable structure of the aircraft. For purposes of the present invention, the attachment surface of the aircraft will be shown as element 52. The visual tool 20 is fixed to the aircraft 52 by the mount 42 such that the indicator body 24 presents a visual representation of level flight to the viewer when the aircraft is level. Because the visual tool 20 is fixed to the aircraft, it moves with, thereby assumes, and indicates the orientation of the aircraft relative to the level plane P (FIGS. 4-8).

The container 22 can be filled with the indicator fluid 26 to a level that is half of the volume of the container interior. Thus, if the volume of the container 22 is 100 cubic centimeters, the indicator fluid 26 amounts to about 50 cubic centimeters of liquid. The indicator fluid 26 can include one or more of water, oil and an organic solvent, e.g., alcohol such as ethyl alcohol or propyl alcohol. Other suitable organic solvents include acetonitrile, ethers such as butyl ether, N,N-dimethyl formamide, N,N-dimethyl acetamide, sulfolane, dimethyl sulfoxide, halogenated solvents such as dichloroethane, dichloromethane, and carbon tetrachloride, aromatic and aliphatic hydrocarbons such as toluene, chlorobenzene, and dichlorobenzene, and xylene, and hexane, octane, decane or dodecane. Examples of oils include castor oil, olive oil, canola oil, peanut oil, sesame oil, and motor oil. Other fluids are contemplated, such as organic fluids and mixtures of flowable materials. In one aspect of the present invention, the indicator fluid includes a color, which can be in the form of a pigment or dye or the like for easy visibility of the level and attitude of fluid within the container 22. It will be understood that the liquid used for the indicator fluid 26 will not freeze or boil under storage or operating conditions. In addition, the liquid should not be toxic or obscure visual inspection of the indicator body 24, or react with any of the elements of the tool 22 exposed to the liquid. A very low viscosity liquid can move in an undesirable fashion and render the surface thereof difficult to read and a very high viscosity liquid cannot respond quickly enough to assist the viewer in determining the attitude of the aircraft during operation. Therefore, the fluid can, in one embodiment, have a viscosity in the range of about 0.009 Ps a to about 0.05 Ps a, e.g., 0.01 to 0.05, or 0.02 to 0.05 (at 20° C.). In one embodiment, the color of the fluid 26 will be a contrast to a color of the indicator body 24.

Preferably, the liquid will not vaporize and condense on the interior of the container 22 so as to avoid obscuring visual inspection of the interior elements. Therefore, the tool 20 should be assembled with liquid and gas that does not enable condensation. For example, the gas could be a gas from which water and other condensable materials are removed. In an alternative embodiment, the container 22 can be filled with two non-miscable liquids of different densities in contrasting colors or another characteristic such that the viewer can discern the top surface of the bottom of the two liquids or an interface therebetween. Use of two liquids in contrast would eliminate condensation.

An optional feature of the tool 20 according to one embodiment is a baffle or partition 44 (FIG. 2) attached to the interior of the container, preferably below an equator thereof. The tool 20 may contain a plurality of baffles 44. In one embodiment, the color of the partition is selected in such a way so that the pilot looking at the visual tool 20 will be able to distinguish the liquid level 26 from the partition 44 within the container 22 of the visual tool. The partition can be configured to divide the interior of the container into two compartments, an upper compartment 46 and a lower compartment 48. Openings 50 are formed through the partition 44 so that the free flow of fluids is possible between the two compartments 46, 48 of the container 22. In one embodiment, the partition 44 is a panel that includes the indicator body 24. In another embodiment, the partition is formed solely by the indicator body 24. The panel 44 can provide a damping benefit to reduce unwanted or confusing motions of the indicator fluid 26 within the container 22 induced by motion and/or vibrations of the aircraft.

When the indicator body 24 is an airplane shape it is possible to readily provide a visual cue of the attitude of the aircraft to the pilot or other viewer. When the indicator body 24 within the container 22 tool is shaped like an airplane, the visual tool 20 can be mounted on the instrument panel 52 of the cockpit in one of several different orientations. In one aspect of the present invention, the visual tool 20 is mounted in a position that provides the pilot with a rear view of the indicator body 24 within the visual tool. In another aspect of the present invention, the visual tool 20 is mounted in a position that provides the pilot with a frontal view of the indicator body 24 within the visual tool. In yet another aspect of the present invention the visual tool 20 is mounted on the instrument panel 52 of the cock pit using a rotatable base 142, as shown in FIG. 1, so that the pilot will be able to rotate the visual tool 20 into either one of the frontal or rear views described above or other desired orientations.

The container 22 can be filled with the indicator fluid 26 so that liquid level touches the indicator body 24 when the visual tool 20 is at rest. When the container 22 is half filled with indicator fluid 26 and mounted on the instrumentation panel 52 of the cockpit of an aircraft, the surface of the indicator fluid within the hollow sphere is parallel to the level plane P irrespective of whether the aircraft is at rest on the ground or flying in the air. However, when the aircraft is ascending at an angle, descending at an angle, or taking a left turn at an angle or right turn at an angle, the indicator body 24 is caused to move relative to the level plane P. When the aircraft is level flying or at rest on a level surface of the earth, the indicator fluid 26 within the container 22 as well as the position of the indicator body 24 within the container are parallel to the level plane P. As a result, the level of liquid of the indicator fluid 26 is aligned with the indicator body 24 as shown in FIG. 4.

When the aircraft is descending (losing altitude) relative to the surface of the earth, the surface of the liquid of the indicator fluid 26 within the container 22 remains parallel to the level plane P. FIG. 7 shows a signal indicative of descending. When the aircraft is descending the “nose” of the indicator body 24 within the visual tool 20 is pointed and immersed into the indicator fluid 26 while the “tail” of the indicator body 24 within the visual tool 20 is pointed out of and protruding above the liquid surface as in FIG. 7.

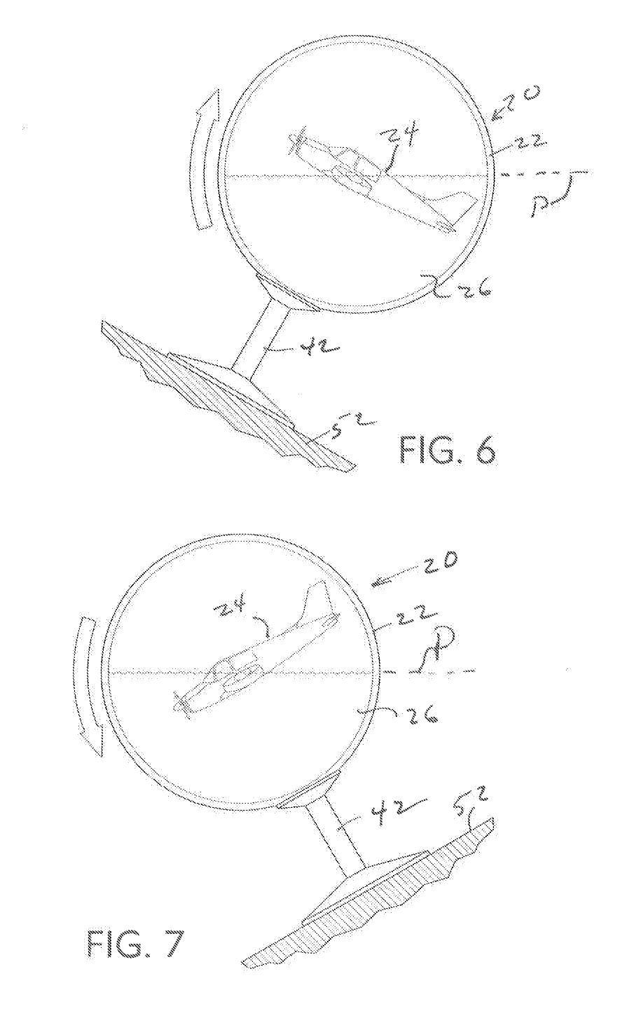

When the aircraft is ascending (increasing altitude), the surface of the liquid within the container 22 is parallel to the level plane P. FIG. 6 shows a signal indicative of ascending. When the aircraft is ascending the “nose” of the indicator body 24 within the visual tool 20 is pointed out of the indicator fluid 26 while the “tail” of the indicator body 24 within the visual tool 20 is pointed into and immersed into the liquid surface as in FIG. 6.

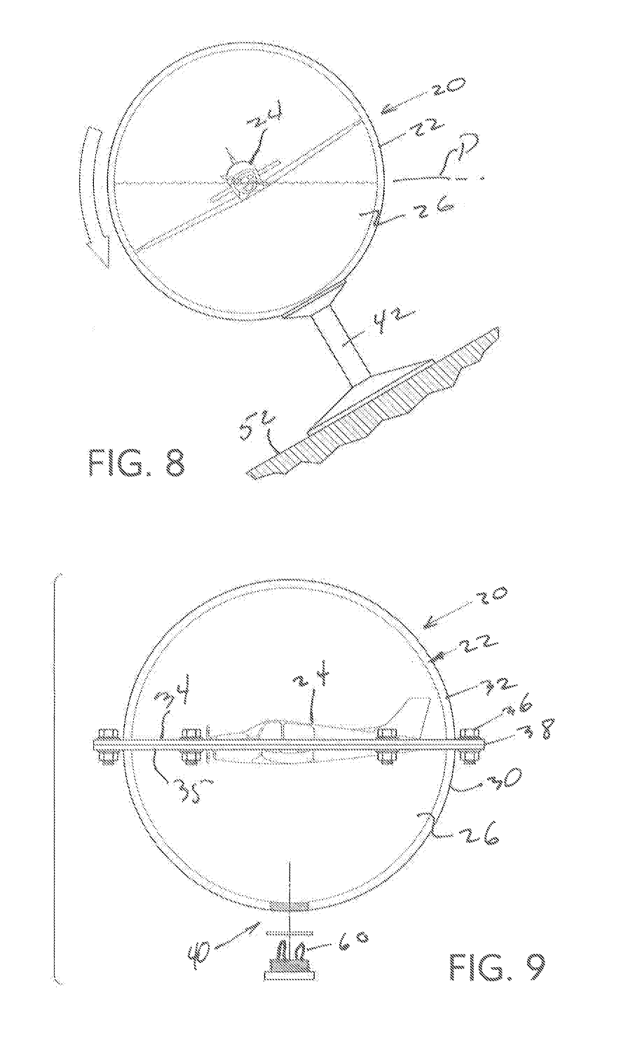

When the aircraft is turning (banking), the surface of the liquid within the container 22 remains parallel to level plane. FIG. 8 shows a signal indicative of banking. When the aircraft is banking, the “wings” of the indicator body 24 within the visual tool 20 are not aligned with the surface of the liquid of the indicator fluid 26. One wing is out of the fluid while the other is immersed within the fluid.

In another embodiment of the present invention, the visual tool 20 of the present invention is provided with built-in illumination 60 (FIG. 9). In one aspect, the illumination 60 is provided at the base of the container 22. Other suitable positions of the illumination are contemplated. For example, the illumination can be provided using one or more light emitting diode.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments can become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A visual tool for determining the spatial orientation of an aircraft relative to a level plane, comprising:
a closed container constructed of a material that permits the passage of light therethrough;
an indicator body fixed within the container and viewable through the container; and
an indicator fluid, the indicator fluid comprising a liquid that fills the container to a selected level, the indicator fluid presenting a fluid surface that is viewable through the container and free to move within the container,
wherein when the visual tool is affixed to an aircraft, the indicator body and the fluid surface are parallel to level plane when the aircraft is level, and
wherein the indicator body is moved out of the level plane and the fluid surface remains parallel to level plane when the aircraft deviates from level plane to generate a visual signal representative of the orientation of the aircraft.

2. The visual tool of claim 1, wherein the container is translucent or transparent.

3. The visual tool of claim 2, wherein the container is made out of glass or plastic.

4. The visual tool of claim 1, wherein the container is one of spherical, rounded, square, rectangular shape.

5. The visual tool of claim 1, wherein the liquid includes a colorant.

6. The visual tool of claim 5, wherein the container defines a volume and the liquid fills about half of the volume.

7. The visual tool of claim 5, wherein the liquid is one or more of a water-based fluid, an organic-based fluid, and an oil-based fluid.

8. The visual tool of claim 1, wherein the indicator body is in the shape of an aircraft.

9. The visual tool of claim 9, wherein the aircraft is an airplane.

10. The visual tool of claim 1, wherein the container is sized and shaped to be attached to the top of an instrument panel of an aircraft cockpit in the visual field of the pilot.

11. The visual tool of claim 1, further comprising a mount that is configured to attach the container to a structural element of the aircraft.

12. The visual tool of claim 1, further comprising an illumination device configured to illuminate an interior of the container.

13. The visual tool of claim 12, wherein the illumination device is a light emitting diode.

14. The visual tool of claim 1, wherein the container comprises the indicator fluid and a second fluid, the indicator fluid and the second fluid filling the container.

15. The visual tool of claim 14, wherein the second fluid non-miscable with the indicator fluid.

16. The visual tool of claim 15, wherein the second fluid is of a lesser density than the first.

17. The visual tool of claim 16, wherein the second fluid permits viewing of an interface between the indicator fluid and the second fluid.

18. The visual tool of claim 17, wherein the indicator fluid is a darker color than the second fluid.

19. The visual tool of claim 18, wherein the second fluid is clear.

20. A method of indicating the spatial orientation of an aircraft relative to a level plane with a visual tool affixed thereto, wherein the visual tool has an indicator body viewably housed within and fixed to a container and a liquid filling a portion of the container, the method comprising:
operating the aircraft parallel to or not parallel to the level plane;
permitting a surface of the liquid to be parallel to the level plane regardless of the spatial orientation of the aircraft;
causing the indicator body to align with the spatial orientation of the aircraft;
wherein, when the aircraft is parallel to the level plane, the indicator body and the surface of the liquid are aligned, and when the aircraft deviates from the level plane, the indicator body and the surface of the liquid are non-aligned; and
determining the spatial orientation of the aircraft by comparing the alignment of the indicator body to the surface of the liquid.
